(19) United States
(12) Patent Application Publication
(10) Pub. No.: US 2006/0085083 A1
(43) Pub. Date: Apr. 20, 2006

(54) Methods and system for conducting research and development on an urban scale

(76) Inventors: Robert Congel, Fayetteville, NY (US); Robert D. Lusk, Sadler, TX (US); Bruce A. Kenan, Skaneateles, NY (US); Robi L. Banerjee, Syracuse, NY (US); Richard C. Pietrafesa JR., Syracuse, NY (US); Stephen Congel, Skaneateles, NY (US); Mike Lorenz, Fayetteville, NY (US); Tina O'Mara, N. Syracuse, NY (US); David M. Aithen, Syracuse, NY (US)

Correspondence Address: CHADBOURNE & PARKE LLP, 30 ROCKEFELER PLAZA, NEW YORK, NY, 10112, US

(21) Appl. No.: 11/215,840

(22) Filed: Aug. 29, 2005

Related U.S. Application Data
(60) Provisional application No. 60/636,339, filed on Dec. 14, 2004.
(60) Provisional application No. 60/607,232, filed on Sep. 3, 2004.
(60) Provisional application No. 60/607,092, filed on Sep. 3, 2004.
(60) Provisional application No. 60/607,093, filed on Sep. 3, 2004.
(60) Provisional application No. 60/607,094, filed on Sep. 3, 2004.
(60) Provisional application No. 60/607,058, filed on Sep. 3, 2004.
(60) Provisional application No. 60/607,144, filed on Sep. 2, 2004.
(60) Provisional application No. 60/607,145, filed on Sep. 2, 2004.
(60) Provisional application No. 60/606,999, filed on Sep. 3, 2004.
(60) Provisional application No. 60/616,595, filed on Oct. 6, 2004.

(51) Int. Cl. G06Q 99/00; G05B 19/418

(52) U.S. Cl. 700/8; 705/1; 705/8; 705/9

(57) ABSTRACT

A system and method is described for conducting research and development on an urban scale for the benefit of the urban community and communities at large. The system and method includes using financial and information technology (IT) models to construct a facility, attract participants to such a facility, and enabling these participants to engage in natural real world behaviors that has not been currently addressed in the art due to the complexity of creating such a facility. The urban community as well as communities at large benefit from information gathered and evaluated from fact9rs that affect an urban community such as, but not limited to, building construction, environment and bioremediation, energy systems, transportation systems, consumer behavior, complex environments, integrated security systems, and other systems that are vital to an urban community.

### CLAIM FOR PRIORITY

This application claims priority to the following provisional applications: 60/636,339, titled “Method and System for conducting Research and Development on an Urban Scale,” filed Dec. 14, 2004; 60/607,232, titled, “Methods and Systems for Developing Compact Human-Engineered Water Remediation Processes Mimicking Natural Process,” filed Sep. 3, 2004; 60/607,092, titled, “Methods and Systems for Modeling and Controlling Localized Fish Species Habitats in a Water Body,” filed Sep. 3, 2004; 60/607,093, titled, “Methods and Systems for Optimizing A Body of Water to Support the Health of Particular Fish Species,” filed Sep. 3, 2004; 60/607,094, titled, “Methods and Systems for Developing and Deploying a Realistic, Virtual Fishing Experience Which Provides Opportunities For Learning To Fish and Instantaneous Experience,” filed Sep. 3, 2004; 60/607,058, titled “Methods and Systems for Generating and Collecting Real-Time Experimental Feedback on the Operation of Fishing Equipment, filed Sep. 3, 2004; 60/607,144, titled “Method and System for Optimizing the Economic Impact of Public Finance Incentives,” filed Sep. 3, 2004; 60/607,145, titled, “Method and System for Optimizing the Economic Impact of Public Finance Incentive,” filed Sep. 3, 2004; 60/609,999, titled “Methods and Systems for Private Financing of Development Projects Having Public Funding Purpose,” filed Sep. 3, 2004; 60/616,595, titled, “Method and System for Financing Infrastructural Improvements,” filed Oct. 6, 2004; Ser. No. ______, titled “Method and System for Allocating Insured Risks” filed Jul. 19, 2005 (Specification will be amended to add the Serial Number when it is issued), which are each herein incorporated by reference.

### FIELD OF THE INVENTION

The present invention relates generally to methods and systems for conducting research and development on an urban scale. More particularly, the present invention relates to the process of constructing a facility through financial and IT models to obtain information never before obtainable on a large scale for the benefit of large urban communities.

### BACKGROUND OF THE INVENTION

It is well known in the art that the function of research is the scholarly or scientific investigation of particular phenomena or hypotheses. More specifically, it is inquiry as to the nature of particular phenomena, followed by the close, controlled and careful study of activities illustrative of the phenomena under study.

In many fields of research, the controlled and painstaking activity necessary to scientific study is a practical impossibility. On larger scales, such is in an urban environment, it is literally impossible to monitor all facets of this environment to obtain the data necessary to evaluate the hypothesis or phenomena. In such instances, scientific research of the phenomena under study is possible only through the use of models. For this reason, researchers in many fields create and study models of natural phenomena. Models enable the use of accepted standard methods of research and analysis that would be impossible to perform in a naturally-occurring environment. However, along with the relative ease afforded through the use of models, there comes the inherent risk that the models do not truly reflect the behavior of the studied phenomena. The use of models for research thus raises the significant risk that the results and conclusions of the research will not accurately reflect real world phenomena.

There is a significant body of literature that examines the implications of the study of models as proxies for the study of actual phenomena. This literature indicates that models do indeed accommodate scientific studies that are investigations comprising controlled experiments, statistical sampling, single variable modifications, reproducibility, and the like. However, the literature also shows that there is a tradeoff in the applicability of the findings back to real world events. While researchers can conduct more rigorous studies of models than of naturally occurring phenomena, the accuracy and utility of their results vary significantly with the accuracy of the model and its fidelity to the actual phenomena of interest.

Many real world phenomena occur on the microscopic or small scale and can be studied in conventional scientific laboratories such as those found in universities and industrial commercial laboratories. On the other hand, large scale and macroscopic phenomena are difficult to model at their natural scale, and so are often studied in the form of smaller models. that can be implemented in conventional scientific laboratories or through random sampling techniques. Examples of such phenomena that occur on the scale of the population and mass of a large city include, but are not limited to, building construction, environment and bioremediation, energy systems, transportation systems, consumer behavior, complex environments, integrated security systems, and other factors that are vital to an urban community. Constructing such a facility, attracting participants to such a facility, and enabling these participants to engage in natural real world behaviors has not been currently addressed in the art due to the complexity of creating such a facility.

Thus, there is a need in the art for researchers to be able to conduct their studies of urban-scale phenomena in an actual, urban-scale model. It would be further desirable and if, such a model were situated in an appropriately sized and controlled environment.

### SUMMARY OF THE INVENTION

The present method and system avoids many of the disadvantages of previous attempts to circumvent these problems of conducting research on such a large scale. The present system and method allows research and development on an urban scale for the benefit of the urban community and communities at large. Human behavior, engineering, technological, and scientific phenomena are studied on an urban scale to allow such information to be used to develop better systems and methods that are more efficient, cost effective, and safer for the urban and surrounding communities. The system and method of the present invention includes constructing a facility that portrays an urban environment in size, demand of public utilities, and other similar features. In one embodiment, detailed urban construction 3-D modeling software, capital funding models, and IT models are utilized to construct the facility to allow the construction with the control necessary to achieve conducting research and development on an urban scale.

The present invention benefits the urban community and the communities at large by providing information and evaluating factors that affect an urban community. Such factors that can be researched and developed by the present invention on an urban scale include, but are not limited to, energy consumption, mass consumption, traffic behavior, safety and security at an urban level, air quality and other environmental concerns at an urban level, consumer behavior, business research, design and. construction on an urban level and other factors that are vital to an urban community.

The method and system of construction such a facility includes 3-D modeling software and efficient work flow processes. A plan for a central information technology utility allows the capture and transmission of behavioral, environmental, and structural information on a real time basis from a broad range of urban components. This feature permits the collection of data that supports the research and development effort.

The method and system of financing such an enterprise includes combining the value of a range of public incentives, creating a funding pool sufficiently large that all the risk can be borne successfully by the private venture. This allows control of the construction of the facility never before seen on such a large scale and permits the building of such a facility to conduct research and development on an urban scale.

These, and other aspects of the system and method of conducting research and development on an urban level, are described in the following brief and detailed description of the drawings.

### BRIEF DESCRIPTION OF THE FIGURES

These and other objects, features and advantages of the present invention will now be apparent from the following Detailed Description of the Invention, when considered in accordance with the Drawing Figures, in which:

FIG. 1 comprises a block diagram illustrating the elements of a research and development facility in accordance with the present invention;

FIG. 2 is a flow chart showing a detailed process for formulating the design of the research and development facility of FIG. 1;

FIG. 3 is a continuation of the chart in FIG. 2 and illustrates a detailed process for developing the centrally-managed construction resources for designing and building the research and development facility of FIG. 1; and

FIG. 4 is a continuation of the chart in FIG. 3 and illustrates a detailed process for financing the design, development and construction of the research and

### DETAILED DESCRIPTION OF THE INVENTION

The present invention permits the advanced study, on an urban scale, of various issues that affect urban environments. Many unanswered questions which have heretofore not been studied and researched on an urban scale can be investigated and solutions developed through the use of the present invention. For example, issues that affect urban cities include, but are not limited to, energy consumption, safety and security, human behavior, air quality and other environmental issues, transportation, financial and commerce issues, among other issues. With the present invention, these issues can be addressed through research and development in a controlled environment yet on a city-wide scale.

The model used to research and develop includes an actual urban sized facility with participants that are freely interacting within the facility. Constructing such a facility that reflects an urban environment, attracting participants to, such a facility, and enabling these participants to engage in natural, real world behaviors are achieved by the present invention as described in greater detail below. By conducting research and development on such a large scale, systems and methods used in an urban environment throughout the country can be made more efficient, more cost-effective, and safer for the benefit of the public and nation.

Two key components in creating such a facility for this research and development initiatives are the information technology (IT) models and financial models developed for the particular purpose of benefiting the public. Specifically, the IT models include the technology of collecting and analyzing data in a large environment. This technology is further described in detail in the attached Appendices B through F. Attached for the reader's convenience are Appendices that further explain in detail the present invention. The attached specifications are separated for the reader's convenience and are not meant to limit the description of a particular feature of the invention to a particular specification in the attached Appendices. Every attached specification in the Appendices may be used to further describe the present invention.

The financial models, also further illustrated in detail in the attached Appendix A include both private and government funding to give the entire risk and control of the construction and operation of the facility to the private venture entity. This control is needed for the success of the research and development initiative. Typically, on construction projects of this magnitude, for example in the construction of a shopping mall, other entities such as anchor stores would contribute to the financing of the facility and have some control over the construction of the facility. Such divided control in the construction of the facility could lead to pursuit of divergent goals and the inevitable failure of creating a facility that is conducive to conducting research and development on an urban scale for the benefit of the public.

The present invention enables research to be conducted in this facility that was heretofore unprecedented in scale and scope. As a first of its kind, the facility enables businesses, the, scientific community, and consumers to interact in new ways never before imaginable. In particular, the facility provides opportunities to explore inter-relationships, behavior, and science among people, processes, and objects for the benefit of the public and our nation.

Research and development conducted in this facility is aimed at the benefit of the public. Such research and development includes, but is not limited to, areas of scientific advancements. For example, research and development of construction of structures, security issues, environmental and air quality issues, energy consumption, transportation technologies, material science, communication technologies, and the like, are also envisioned.

Design and construction processes will also be available for research and development. This includes, but is not limited to, electronic replication or digital double of physical environment, virtualization and sourced business functions, physical design for. continual renewal, operating processes, learning organization design for renewal and the like.

Consumer research and development will also be available in this facility. For example, this research will include, but is not limited to, selection of preferences, perception issues, behavior science issues, in small groups, large groups and different settings with the same participants, peer influence, and education and learning issues.

Business research will be available in this facility. Such research will include, but is not limited to business processes, human resources business to business transactions, business to consumer transactions, financial transactions, office functions and efficiencies and information and communication technologies.

Constructing such a facility, attracting participants to such a facility, and enabling these participants to engage in natural real world behaviors are features of this invention that can not be understated. The complexity of creating such a facility is an enormous undertaking as is attracting participants to engage in activities offered at the facility. These aspects are further discussed below in further detail of the Figures.

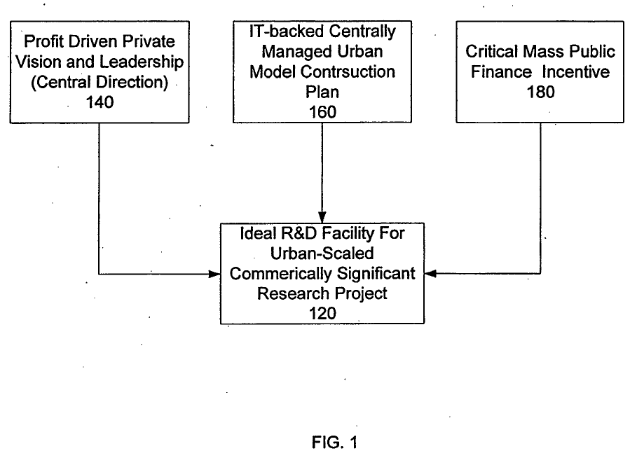

With reference now to FIG. 1, there is shown a block diagram 100 of a conceptual research and development facility 120 concomitant with the critical developmental elements used to create the development facility.

In accordance with the present invention, one important element of a research and development facility in accordance with the present invention is the use of public financial incentives 180 to finance at least a significant portion of the facility.

Another element of the present invention is the use of a centrally managed information technology construction and operations management system 160 to plan and controlled the development and operations of the facility 120.

Yet another element of the present invention involves centralized, private-vision leadership 140 used to design, construct and manage the facility 120. This element is necessary to complete the project and utilize the facility for the benefit of obtaining research and development at an urban level as previously discussed.

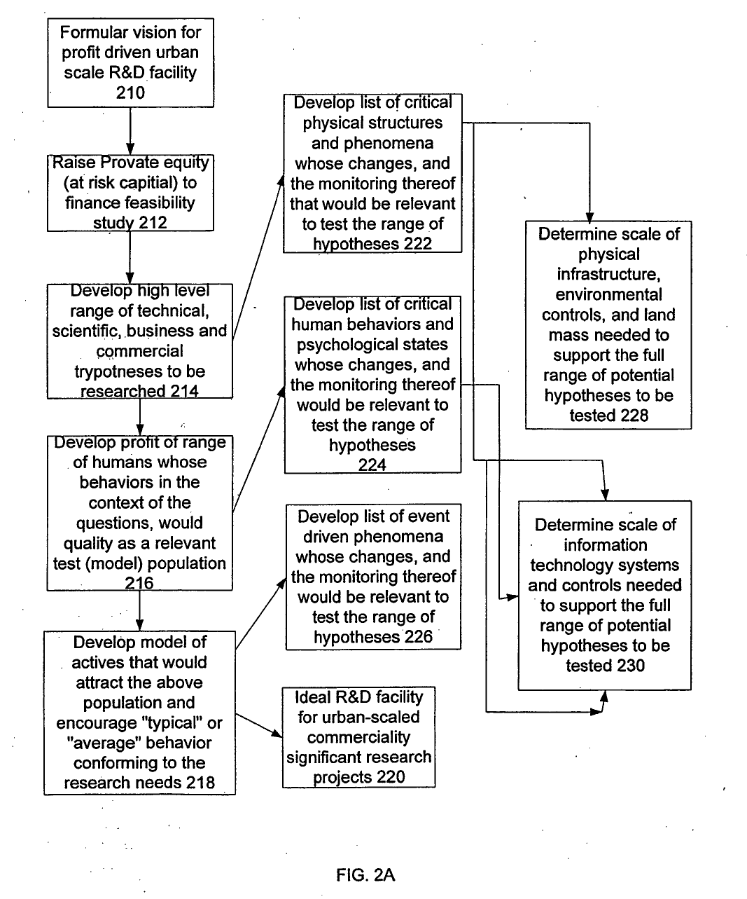

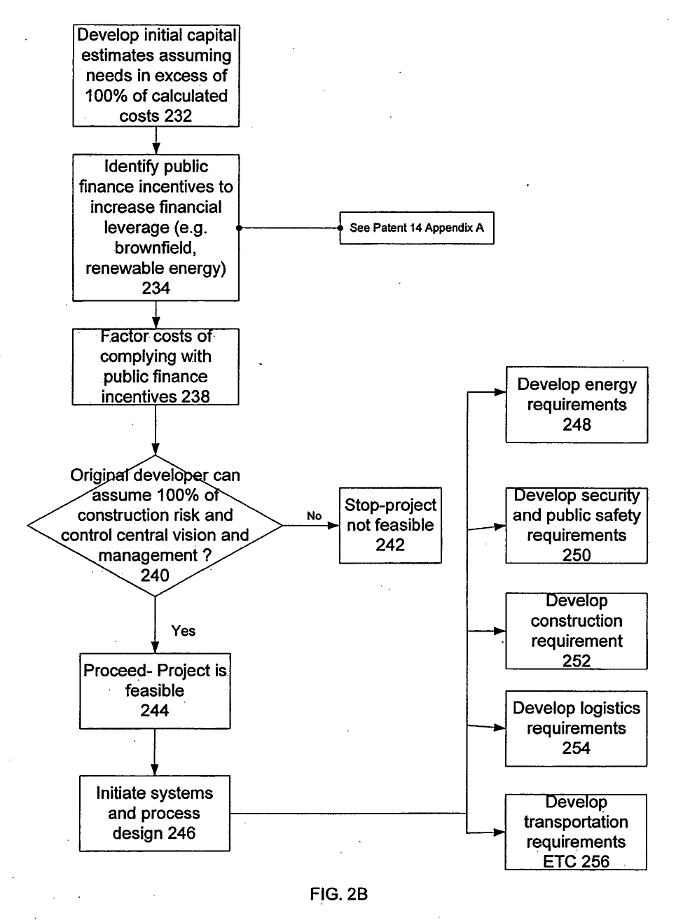

With reference now to FIGS. 2, 3, and 4 various details of the process articulated in FIG. 1 are shown. In accordance with the present invention, a vision is formulated to develop the profit driven urban scale research and development facility as shown in step 210. Subsequent to the formulation of the vision, private equity is raised to finance a study of the feasibility of developing and building the facility 120 as shown in step 212.

Important in any scientific research is the hypothesis to be researched. As indicated in step 214, a high level range of technical, scientific, business and commercial issues to be researched are developed. These issues can range from the simplest to complex issues that affect an urban sized environment.

A characteristic map indicating a participant's profile is developed. This map illustrates the type of participants whose behavior is in line with the context of the issue to be researched as shown-in step 216. Step 218 illustrates development of activities to attract the population in step 216 to allow the ideal research and development of the selected issue on an urban scale as shown in 220.

Step 214 also involves the development of a list of critical physical structures and phenomena whose changes (and the monitoring of those changes) are relevant to the tested hypothesis as shown in step 222. Step 222 results in determination of the scale of physical infrastructure, environmental controls, and land mass needed to support the testing of the hypothesis as shown in step 228. This step could involve the entire urban sized facility or a portion of the urban sized facility. This feature can be particularly useful if an issue only affects a certain area of a large city, and research is desired to be done to develop solutions to the issue on an urban scale. Therefore, the facility has the capability of providing research and development opportunities on both an entire urban level and a portion of the urban level.

Step 230 illustrates, for example, determining the scale of information technology systems and controls needed to support the full range of potential hypotheses to be tested. This step is subsequent to step 222 previously described as well as step 224 and step 226 that are in relation to step 216 and step 218, respectively.

Step 224 is one illustration of developing a list of critical human behaviors and psychological states whose changes and the monitoring of those changes are relevant to the hypothesis being tested. Step 226 involves, developing a list of event driven phenomena whose changes and the monitoring of those changes would be relevant to the hypothesis being tested. For example, in one embodiment, an event such as a sound recording of a popular teenage talent at the facility would draw populations and participants of a certain age group if required in testing the issue or hypothesis selected. One example for step 224 for the list of behaviors includes monitoring the behavioral effect in terms of air quality and traffic flow in and out of the event and its environmental impact to the urban sized facility.

Both step 228 and step 230 in the illustrated embodiment flow to step 232 that represents developing initial capital estimates assuming that the need for testing the hypothesis is in excess of 100% of the calculated costs.

Public finance incentives are identified in step 234. In this step, the public finance incentives are used to increase financial leverage. Examples of these incentives include, but are not limited to, Brownfield tax credits, renewable energy tax credits and the like. Appendix A provides more details to this process as shown in step 236.

Attached hereto for the reader's convenience is Appendix A through F. This Appendix provides specifications to illustrate examples of how the urban research facility can develop solutions to the issues that may affect it and the urban community in general. This is merely given as examples and are in no way meant to limit the scope of this invention to the embodiments illustrated.

Step 238 in this embodiment factors the costs for complying with the public incentives. As previously discussed, autonomy in decisions made concerning the facility is an important factor in the research and development capability of the facility.

As step 240 signifies, if the original developer cannot assume 100% of the construction risk and control for central vision and management of the facility, then the project is stopped, as shown in step 242. However, if the above management capability is possible then the project proceeds as shown in step 244.

Systems in the facility are initiated and process design begins in step 246 to further test the selected hypothesis in an urban environment. Several requirements must be developed in order for the facility to handle the testing of the hypothesis. These requirements include, but are not limited to, energy requirements, security and public safety requirements, construction requirements, logistics requirements, transportation requirements and other requirements needed to test the hypothesis in an urban environment facility. The development of these requirements is illustrated, respectively, in steps 248, 250, 252, 254, and 256.

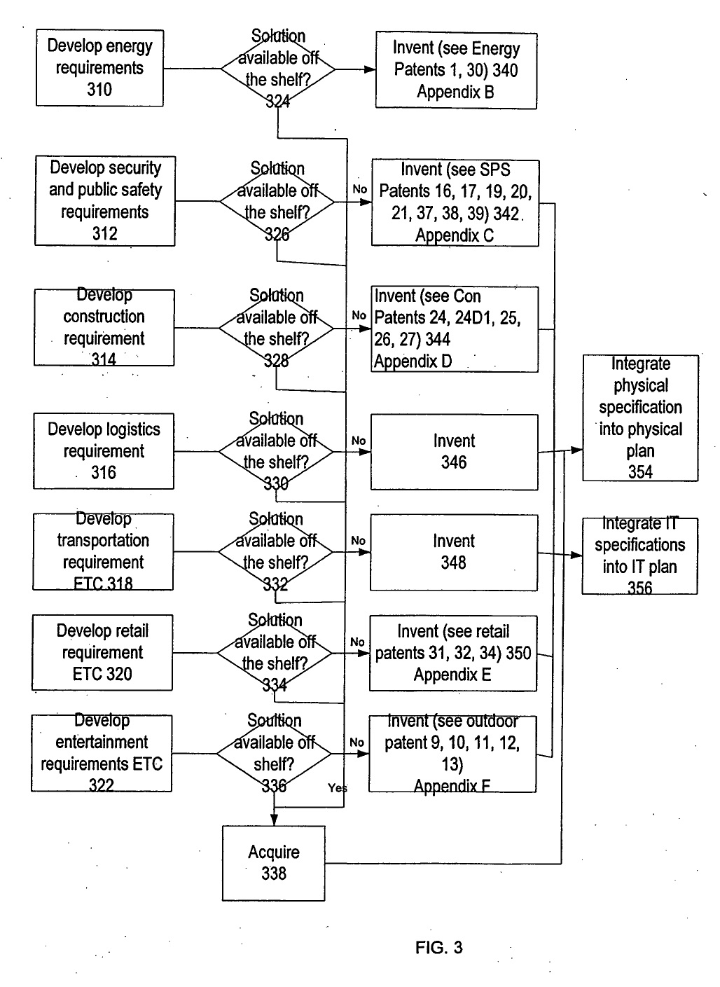

Continuing now with FIG. 3, which is a continuation from FIG. 2, there is illustrated the requirements necessary in one embodiment for the urban research facility. Depicted are similar requirements illustrated in FIG. 2. Development of requirements in step 248 through step 256 is represented in steps 312, 314, 316, and 318, respectively. Two additional requirements are illustrated in FIG. 3 as represented in step 320 and step 322.

Step 320 illustrates developing retail requirements. Retail requirements can include for example, but are not limited to, required floor space, location of product and advertisement, and other related requirements.

Step 322 concerning the development of entertainment requirements can include for example, but are not limited to, the talent to be hired, positioning of stage equipment, environmental impact, if any, of providing the entertainment, effects of providing the entertainment on traffic patterns and public safety. These requirements and more may all be considerations in the hypothesis to be tested. The benefits again are that the urban sized facility can research the pertinent issues and develop systems to cope with any items that may negatively impact the urban community. Thereby providing a better community.

Steps 324, 326, 328, 330, 332, 334, 336, and step 338 all illustrate the query to each respective development requirement as to whether the solution is currently available or not. If the solution is available, it is acquired as illustrated in step 338.

If the solution to the requirement is not currently available, then the solution is developed through innovative processes as illustrated in steps 340, 342, 344, 346, 348, 350, and step 352. The solutions are developed to solve challenges unique to the construction and operation of an urban scaled research facility, and then the solutions, themselves, become hypotheses that are then tested in the urban research facility.

Step 340 illustrates an example in Appendix B of developed solutions to energy requirements. Appendix C in step 342 illustrates and example Of developed processes for security and public safety.

Step 344 depicts Appendix D that gives one example of developed solutions to construction requirements.

Appendix E of step 350 illustrate embodiments of developing solutions to retail requirements. Appendix F depicts embodiments of developing solutions to issues brought about by entertainment requirements.

Regardless of whether the solution is off the shelf or developed, physical specifications are integrated into a physical plan as illustrated in step 354 and integrated into information technology (IT) specifications and plans in stop 356. This allows the solution to the requirement to become part of the research mission.

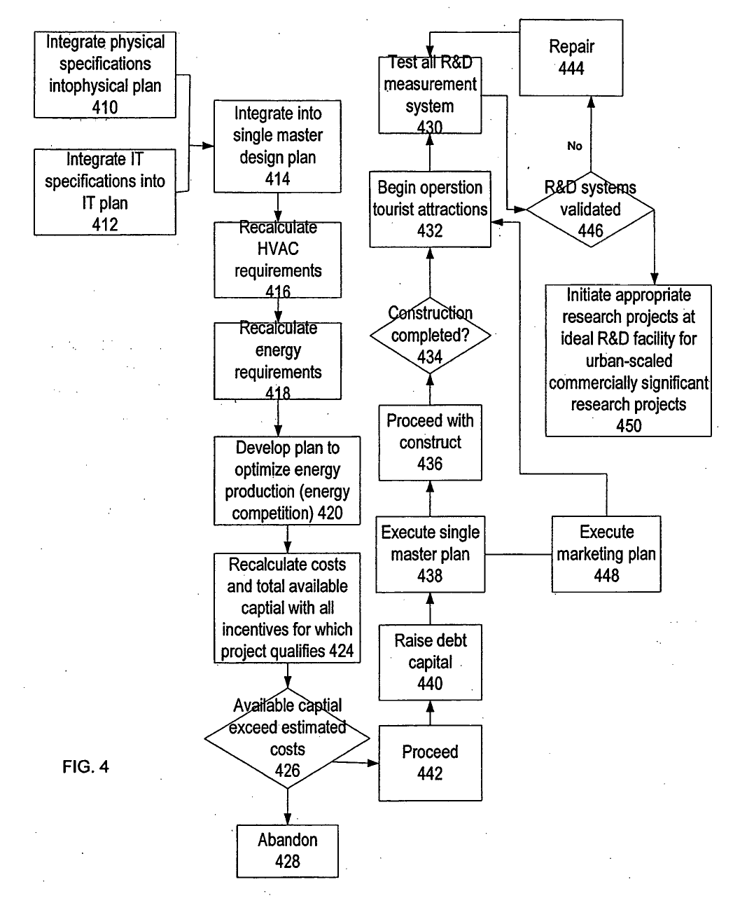

FIG. 4 illustrates the physical and IT integration shown in steps 354 and 356 as steps 410 and 412. This process continues in step 414 where the integration into a single master plan is accomplished. Recalculation of heating ventilation and air conditioning requirements in the urban research facility is done in step 416. Energy requirements are also recalculated taking into account the integration of the solutions in steps 410 and 412. This energy recalculation is illustrated in step 418.

Step 420 is one example of developing a plan to optimize energy production and force energy competition. Costs and total capital available are recalculated with all the incentives for which the project of building the research urban facility has obtained.

If the total available capital does not exceed the estimated cost of building, the facility then the project is abandoned as shown in step 426 and step 428. If the total capital does exceed the estimated costs then the project proceeds as illustrated in step 442.

Debt capital can now be raised as indicated in step 440. A single master plan is then executed in step 438 ad construction of the research urban facility commences as shown in step 436.

If construction is not completed, reversion to step 436 is done as indicated in step 434. If construction is completed, tourist attractions begin to operate at the facility. These tourist attractions allow participants to become involved in the research process for the benefit of urban communities and society.

All research and development systems are tested in step 430. If the systems are not validated, repair is done in step 444. Otherwise, step 446 leads to the initiation of appropriate research projects at an ideal research and development facility for urban scaled commercially significant research projects.

It should be understood that the above description is only representative of illustrative examples of embodiments and implementations. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent.

We claim:

1. A method of conducting research and development on an urban scale comprising:
acquiring funding through private and public initiatives in a manner that allows private control of the design and construction of an urban sized facility; and
constructing a integrated controlled environment and providing appropriate information technology in the facility for the collection and analysis of data throughout the urban sized facility for the research of issues and development of solutions for the issues that affect urban communities and the nation.

2. A computerized system for conducting research and development on an urban scale comprising:
a memory device; and
a processor disposed in communication with the memory device, the processor configured to acquire funding through private and public initiatives in a manner that allows private control of the design and construction of an urban sized facility, and locate appropriate information technology in the facility for the collection and analysis of data throughout the urban sized facility for the research of issues and development of solutions for the issues that affect urban communities and the nation.

3. A controlled environment comprising an integrated urban scale replica of a city, comprising:
means for attracting an urban scale statistically random population;
means for controlling all activities and environmental events in the urban replica;
means for measuring and monitoring all activities, phenomena and structures in the urban replica;
means for analyzing the data captured through the measurement and monitoring of all activities, phenomena, and structures in the urban replica;
means for controlling individual variables of the urban replica through complete control of the operations of the urban replica; and
means for obtaining control by centralizing the financing of the construction of the urban replica.
